(19) United States
(12) Patent Application Publication
(10) Pub. No.: US 2007/0109039 A1
(43) Pub. Date: May 17, 2007

(54) Reference circuit capable of supplying low voltage precisely

(76) Inventor: Hirofumi Watanabe, Miki-shi (JP)

Correspondence Address: COOPER & DUNHAM, LLP, 1185 AVENUE OF THE AMERICAS, NEW YORK, NY, 10036, US

(21) Appl. No.: 11/594,364

(22) Filed: Nov. 7, 2006

(30) Foreign Application Priority Data
Nov. 7, 2005 (JP) 2005-321937

(51) Int. Cl. G05F 1/10

(52) U.S. Cl. 327/541

(57) ABSTRACT

A reference voltage circuit is provided which includes a first MOS transistor including a first gate, and a second MOS transistor including a second gate. The first gate includes a first conductive type impurity with a concentration less than or equal to 1×10¹² cm⁻³, or no impurity. The second gate includes the first conductive type impurity or a second conductive type impurity with a concentration greater than or equal to 1×10¹⁹ cm⁻³. The reference voltage circuit generates a predetermined reference voltage by utilizing a difference of work functions between the first and second transistors so as to have no temperature dependence.

### TECHNICAL FIELD

The present disclosure relates to a reference circuit, and more particularly to a reference circuit capable of supplying low voltage precisely.

### BACKGROUND

Recently, energy-saving has been actively promoted in terms of environmental measure. For portable equipment using battery such as a mobile phone, a digital camera, and so on, it is especially desirable to have a longer battery life. Such portable equipment commonly uses a constant voltage circuit which supplies a low voltage power. The constant voltage circuit generally includes a reference voltage circuit to obtain the stable low voltage.

Several reference voltage circuits which employ bipolar transistors (bipolar reference voltage circuit) are proposed. One example of conventional bipolar reference voltage circuits utilizes a negative temperature dependence of a base-emitter voltage Vbe of a bipolar transistor with a positive temperature dependence of a potential difference ΔVbe between base-emitter voltages of two transistors. This bipolar reference voltage circuit is so-called band gap reference circuit.

However, the band gap reference circuit can output around 1.25 v as a lowest voltage and needs a power supply voltage of at least 1.25 v+α to operate. It is not possible to obtain a low voltage lower than 1.0 v. To achieve low voltage operation using the band gap reference circuit, a complicated and large circuit may be needed.

Meanwhile, several reference voltage circuits which employ MOS (metal-oxide silicon) transistors are proposed (MOS reference voltage circuit). One example of the MOS reference voltage circuit utilizes a potential difference of threshold voltages of an enhancement type MOS transistor and a depression type MOS transistor which is formed by controlling an impurity concentration in a substrate or in a channel region.

However, the reference voltage in such MOS reference voltage circuit may be affected easily by process fluctuations because it is necessary to control two MOS transistors. An absolute value of the threshold voltage and a temperature dependence especially on the depression MOS transistor are strongly affected by the manufacturing process. As a result, the reference voltage may have large deviation on the absolute value and temperature dependence of the reference voltage. Thus, it is difficult to obtain a stable reference voltage precisely.

Another example of the MOS reference voltage circuit utilizes a difference of work functions of gate electrodes of the two MOS transistors. The MOS reference voltage circuit using a difference of work functions is stable against the process deviation. However, the output voltage is around 1.0 v which is almost equal to a band gap of a poly silicon. Thus, it is difficult to obtain a stable reference voltage below 1.0 v.

### SUMMARY

This patent specification describes a novel reference voltage circuit which includes a first MOS transistor including a first gate, the first gate including a first conductive type impurity with a concentration less than or equal to 1×10¹² cm⁻³, or no impurity, and a second MOS transistor including a second gate, the second gate including the first or a second conductive type impurity with a concentration greater than or equal to 1×10¹⁹ cm⁻³. The reference voltage circuit generates a predetermined reference voltage by utilizing a difference of work functions between the first and second transistors so as to have no temperature dependence.

This patent specification further describes a novel reference voltage circuit which includes first and second MOS transistors connected in series. Gates of the first and second MOS transistors, respectively, are wired to each other, and a potential difference of the source voltages of the first and second MOS transistors is drawn out as a reference voltage.

Further, this patent specification describes a novel reference voltage circuit including first and second MOS transistors, wherein one of the MOS transistors is formed of a depression MOS transistor and a gate of the MOS transistor is wired to a source of the MOS transistor so as to work as a constant current source. A reference voltage is drawn out as a voltage between the gate and the source of another MOS transistor from a node at which a current is supplied from the constant current source.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a reference circuit according to a first exemplary embodiment of the present disclosure;

FIG. 2 illustrates a graph representing a relation of Fermi level versus temperature with parameter of impurity concentration;

FIG. 3 illustrates a graph representing temperature coefficient of a work function difference versus channel length ratio of the MOS transistors;

FIG. 4 illustrates another example of a reference circuit according to the first exemplary embodiment;

FIG. 5 illustrates a reference circuit according to a second exemplary embodiment;

FIG. 6 illustrates a reference circuit according to a third exemplary embodiment; and

FIG. 7 illustrates a reference circuit according to a fourth exemplary embodiment.

### DETAILED DESCRIPTION OF PREFERRED EMBODIMENTS

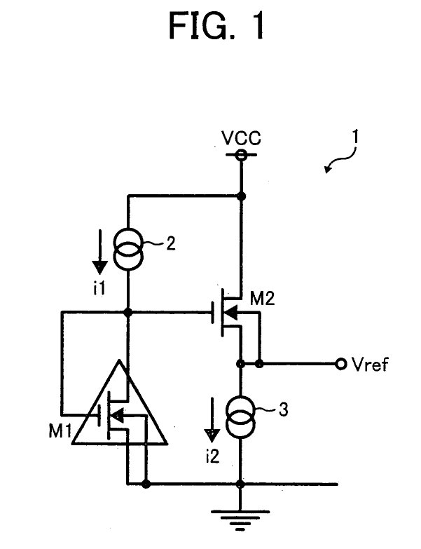

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a reference circuit according to an exemplary embodiment is described.

FIG. 1 illustrates a reference circuit 1 according to a first exemplary embodiment of the present disclosure. The reference circuit 1 includes a first MOS transistor Ml, a second MOS transistor M2, a first constant-current source 2 and a second constant-current source 3. The first MOS transistor Ml is formed of a N-channel type MOS transistor having a lightly-doped gate and the second MOS transistor M2 is formed of a N-channel type MOS transistor having a heavily-doped gate into which impurity is dosed by a larger amount of doping than an amount of doping into the lightly doped gate.

The first constant-current source 2 supplies a predetermined first constant current i1 and the second constant-current source 3 supplies a predetermined second constant current i2. In the reference circuit 1, the gate of the first MOS transistor M1 is wired to the gate of second MOS transistor M2. A reference voltage is drawn out as a potential difference between the source voltages of the first and second MOS transistors.

The first constant-current source 2 and the first MOS transistor M1 are connected in series and the second MOS transistor M2 and the second constant-current source 3 are connected in series between a positive power-supply and a negative power-supply, i.e., a power supply voltage Vcc and a ground voltage GND. Each gate of the MOS transistors M1 and M2 is wired to each other and the connecting node of the gates is wired to a drain of the first MOS transistor M1.

A substrate gate of the first MOS transistor M1 is wired to ground. A substrate gate of the second MOS transistor M2 is wired to a source of the second MOS transistor M2. The first and second constant-current source 2 and 3 supply current to the first and second MOS transistors M1 and M2, respectively, so that each source-drain current of the first and second MOS transistors M1 and M2 becomes equal to each other, i.e., i1=i2. The reference voltage Vref is output from a node between the second MOS transistor M2 and the second constant-current source 3.

A basic concept on this circuit configuration will be described. A threshold voltage Vt is a voltage to form an inversion layer in a channel region and is expressed by the following formula:
Vt=φms−Qf/Cox+2φf−Qb/Cox (1)

where φms is a difference between a work function φm of a gate and a work function of a substrate φs, Qf is fixed charge in an oxide, of is Fermi level of the substrate, Qb is charge in a depletion layer between an inverted layer of the channel region and the substrate and Cox is capacitance per unit area of the oxide.

Therefore, a threshold voltage difference ΔVt between the threshold voltages Vt of the pair of MOS transistors M1 and M2 is expressed by a difference of the work functions of gate materials as shown in the following formula (2):

$$\begin{matrix}Δ Vt = Vt ( M 2 ) - Vt ( M 1 ) \\ = φ ms ( M 2 ) - φ ms ( M 1 ) \\ = φ m ( M 2 ) - φ m ( M 1 )\end{matrix} \qquad ( 2 )$$

where Vt(M1) is the threshold voltage Vt of the first MOS transistor M1, Vt(M2) is the threshold voltage Vt of the second MOS transistor M2, φms(M1) is work function difference φms of the first MOS transistor M1, φms(M2) is work function difference φms of the second MOS transistor M2, φm(M1) is gate work function φm of the first MOS transistor M1 and φm(M2) is gate work function φm of the second MOS transistor M2.

Since the gate is formed of poly-silicon (or poly-silicon covered with silicide on the surface of the poly-silicon) in the MOS transistor structure, the work function φm of the gate is expressed by the following formula (3):
φm=X+Eg/2+φf (3)

where X is electron affinity of poly-silicon, Eg is band gap and φf is Fermi level.

Therefore, the threshold voltage difference ΔVt is expressed by a difference of the Fermi levels of the first and second MOS transistors M1 and M2 as shown in the following formula (4):
ΔVt=φf(M2)−φf(M1) (4)

where φf (M1) is Fermi level φf of the substrate of the first MOS transistor M1 and the φf (M2) is Fermi level φf of the substrate of the second MOS transistor M2.

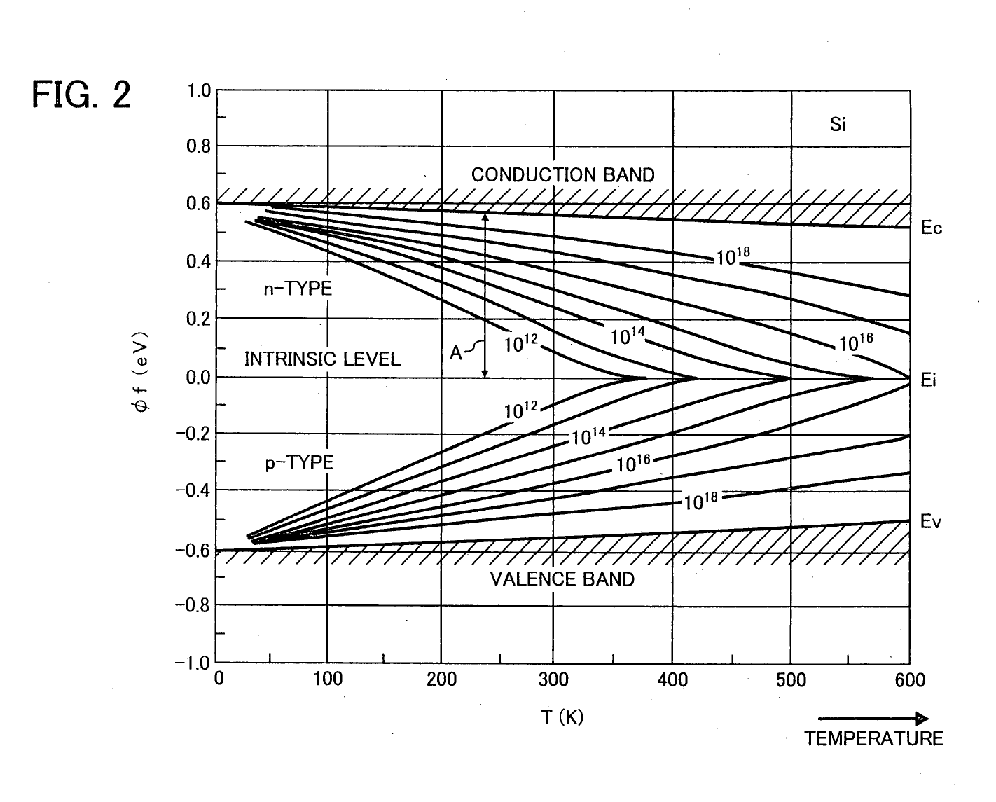

FIG. 2 illustrates a graph representing a relation of Fermi level φf versus temperature with parameter of impurity concentration. The first MOS transistor M1 includes a first gate having a first conductive type impurity with a concentration less than or equal to 1×10¹² cm⁻³, or includes no impurity. The second MOS transistor M2 includes a second gate having the first or a second conductive type impurity with a concentration greater than or equal to 1×10¹⁹ cm⁻³. If the first conductive type impurity is P-type, the second conductive type impurity is N-type (or conversely, the first conductive type impurity is N-type and the second conductive type impurity is P-type).

If the impurity concentration of the first MOS transistor M1 is greater than or equal to 1×10¹⁹ cm⁻³, φf (M2) is nearly equal to band energy of conduction band (Ec) as shown in FIG. 2. If the impurity concentration of the first MOS transistor M1 is less than or equal to 1×10¹² cm³, φf (M2) is nearly equal to intrinsic level Ei of FIG. 2. Namely, φf (M2)-φf (M1) is almost a half of the band gap (Ec-Ev) in this condition as shown by an arrow A when the gate of the first MOS transistor M1 does not include impurity where Ev is band energy of valence band. Accordingly, it may be possible to call a circuit having this condition with “half-band-gap reference circuit”.

The threshold voltage difference ΔVt has a temperature dependence as shown in FIG. 2. If the gate of the first MOS transistor M1 has the same first conductive type impurity as the second MOS transistor M2, the threshold voltage difference ΔVt has a positive temperature dependence. If the gate of the first MOS transistor M1 has the second conductive type impurity, the threshold voltage difference ΔVt has a negative temperature dependence.

The first MOS transistor M1 may be formed to have a different channel length than the second MOS transistor M2 by making transistor sizes unbalanced so as to have a different temperature dependence of mobility of each MOS transistor. As a result, the temperature dependence of the threshold voltage difference ΔVt can be canceled out.

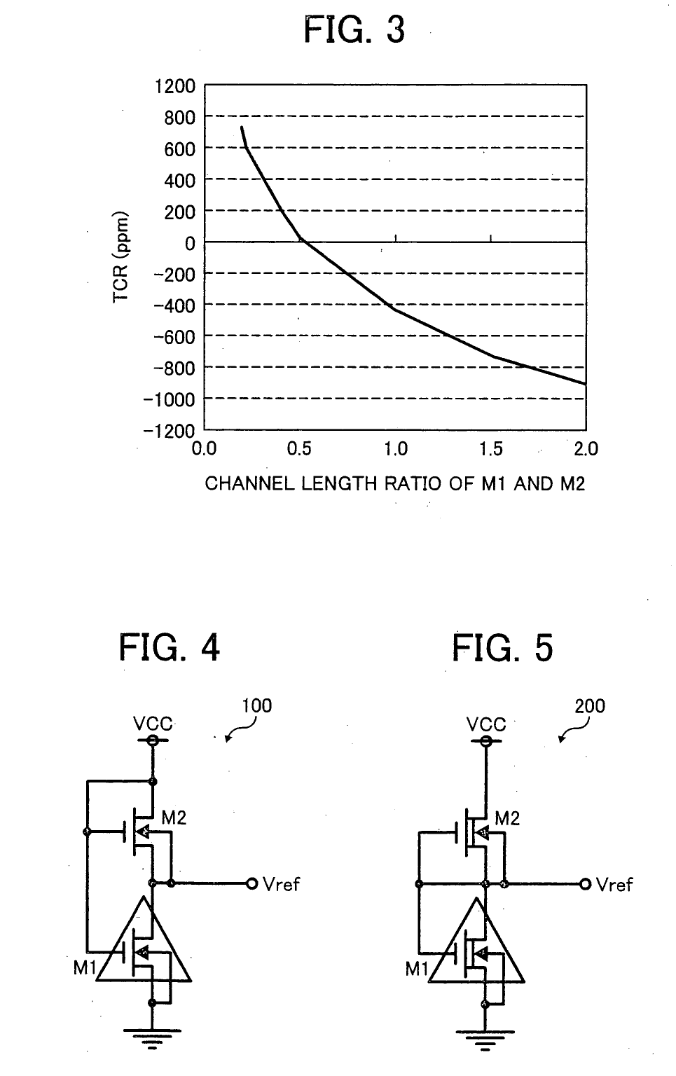

FIG. 3 illustrates a graph representing temperature coefficient of the work function difference versus channel length ratio of the MOS transistors M1 and M2. Namely, FIG. 3 is a graph representing the change of temperature coefficient of the reference voltage Vref (TCR). If the ratio of the channel lengths is designed to be around 0.5, the temperature dependence of the threshold voltage difference can be canceled out and can be zero so that the reference voltage Vref having no temperature dependence can be achieved.

A manufacturing process of the first and second MOS transistors M1 and M2 will be described. The first and second MOS transistors M1 and M2 are basically manufactured using a general CMOS process. Especially on the second MOS transistor M2 which includes a gate having a first or second conductive type impurity with a concentration greater than or equal to 1×10¹⁹ cm⁻³, no additional process other than the conventional CMOS process is needed. For example, if a N-type impurity is selected to be doped, phosphorus can be implanted by a concentration greater than or equal to 1×10¹⁹ cm⁻³ or is introduced from phosphorus glass by solid phase diffusion method. As for the first MOS transistors M1, the gate is formed to have the first conductive type impurity by a concentration less than or equal to 1×10¹² cm⁻³.

The Fermi level of the gate of the first MOS transistor M1 is to be a value close to an intrinsic Fermi level of the silicon to have a stable reference voltage Vref as described. Therefore, it is better to avoid introduction of impurity during the manufacturing process. During the doping process of the impurity in the gate of the second MOS transistor M2, impurity diffusion to the gate of the first MOS transistor M1 is protected by a barrier mask formed on the gate of the first MOS transistor M1 if impurity diffusion process is used, or is protected by a resist mask if ion implantation process is used. Further, impurity diffusion is protected by a silicon nitride film Si₃N₄ if solid phase diffusion method is used.

The first and second MOS transistors M1 and M2 are processed equally at other process steps such as channel dope, formation of gate oxide and so on. As a result, the first and second MOS transistors M1 and M2 have equal dimensional sizes with respect to an area at the substrate side from the gate oxide including gate oxide and equal distribution of the impurity concentration but have different work functions from each other.

A basic concept to draw out the reference voltage will be described. A drain current id of MOS transistor is generally expressed by the following formula (5) in a saturation operating region in which the Vds>Vgs−Vt. Vds is a voltage between drain and source and Vgs is a voltage between gate and source.
id=(β/2)*(Vgs−Vt)² (5)

Drain currents id1 and id2 of the first and second MOS transistors M1 and M2 which have different impurity concentration from each other are expressed by the following formulas (6) and (7):
Id1=(β1/2)*(Vgs1−Vt1)² (6)
Id2=(β2/2)*(Vgs2−Vt2)² (7)
where Vgs1 and Vgs2 are voltages between gate and source of the MOS transistors M1 and M2, respectively. Vt1 and Vt2 are threshold voltages of MOS transistors M1 and M2, respectively. β1 and β2 are conductive coefficients of the MOS transistors M1 and M2, respectively.

A conductive coefficient β of MOS transistor is generally expressed by the following formula (8):
β=μ*(εox/Tox)*(Weff/Leff) (8)
where μ is carrier mobility, εox is dielectric constant of oxide, Tox is thickness of the oxide, Weff is effective channel width and Leff is effective channel length. The following formulas (9) to (11) are obtained from (6) and (7):
Vgs1=Vt1+(2*id1/β1)^{1/2} (9)
Vgs2=Vt2+(2*id2/β2)^{1/2} (10)
Vgs2−Vgs1=(Vt2−Vt1)+{(2*id2/β2)^{1/2}″(2*id1/β1)^{1/2}} (11)

If equal amount of current flow both through the MOS transistors M1 and M2, id1=id2. The formula (11) then becomes the following formula (12):
Vgs2−Vgs1=(Vt2−Vt1)+(2*id2)^{1/2}*{(/β2)^{1/2}−(1/β1)^{1/2}} (12)

When the MOS transistors M1 and M2 are similarly manufactured as if they are a pair of MOS transistor, β1=β2 because the carrier mobility p, the dielectric constant of oxide εox, the thickness of the oxide Tox, the effective channel width Weff and the effective channel width Leff are equal. The formula (12) then becomes the following formula (13):
Vgs2−Vgs1=(Vt2−Vt1) (13)

The difference of the gate-source voltage is the difference of the threshold voltage, i.e., the difference of the work functions. Based on the above assumption, a circuit which can draw the potential difference between gate and source Vgs will be prepared.

In the circuit, the channel length ratio of the MOS transistors M1 and M2 is adjusted so as to cancel temperature dependence. Since β1 may not be equal to β2 in this case, the second term of the formula (12) may not be zero. The potential difference of the gate-source voltage may not explicitly be the difference of the work functions.

However, the potential difference (Vgs2−Vgs1) may still be used for the reference voltage Vref because of the following reasons. The second term of the formula (12) is negligibly small in comparison to the first term of the formula (12). The reference voltage Vref may be almost equal to the difference of the work functions and may be approximately 0.5 v which is a half of the band gap as described.

In FIG. 1, a symbol of the MOS transistor with a triangle represents the first MOS transistor M1 which has a gate with a low impurity concentration. The source voltage of the second MOS transistor M2, which is the potential difference of the source voltages between the first and second MOS transistors M1 and M2, is drawn out as the reference voltage.

The minimum operation voltage of the power supply Vcc is a voltage which is a summation of the reference voltage Vref and the drain-source voltage of the second MOS transistor M2. If the reference voltage Vref is, for example, approximately 0.5 v, the power supply voltage can be set to be lower than or equal to 1 v by setting the threshold voltage of the second MOS transistor M2 with a value lower than or equal to 0.5 v.

FIG. 4 illustrates another example of the reference circuit 100 according to the first exemplary embodiment. The reference circuit 100 includes a first MOS transistor M1 and a second MOS transistor M2. The first MOS transistor M1 has a lightly-doped gate and the second MOS transistor M2 has a heavily-doped gate which is dosed with impurity by a larger amount than the doping in the lightly doped gate.

Both of the first and second MOS transistors M1 and M2 are formed of enhancement type MOS transistors and gates of the first and second MOS transistors M1 and M2 are wired to each other. The reference voltage Vref is drawn out as a potential difference of the source voltages of the first and second MOS transistors M1 and M2.

The first and second MOS transistors M1 and M2 are connected between the power supply Vcc and ground. Each gate of the first and second MOS transistors M1 and M2 is wired to the power supply Vcc. A substrate gate of the first MOS transistor M1 is wired to ground and a substrate gate of the second MOS transistor M2 is wired to the source of the second MOS transistor M2. The reference voltage Vref is drawn out from the connection node of the first and second MOS transistors M1 and M2.

Since the source voltage of the first MOS transistor M1 is the ground voltage GND in this reference voltage circuit 100, the source voltage of the second MOS transistor M2 is equal to the potential difference of the source voltages of the first and second MOS transistors M1 and M2. Therefore, the reference voltage Vref is drawn out from the source of the second MOS transistor M2. Similarly to the case of FIG. 1, if the reference voltage Vref is, for example, approximately 0.5 v, the power supply voltage can be set to be lower than or equal to 1 v by setting the threshold voltage of the second MOS transistor M2 with a value lower than or equal to 0.5 v.

The minimum operation voltage of the power supply Vcc becomes a summation of the reference voltage Vref and the drain-source voltage of the second MOS transistor M2 because the reference voltage Vref is drawn out as a potential difference of the source voltages of the first and second MOS transistors M1 and M2. If the reference voltage Vref is approximately 0.5 v, the power supply voltage can be set to be lower than or equal to 1 v by setting the threshold voltage of the second MOS transistor M2 with a value lower than or equal to 0.5 v.

As a result, it is possible to achieve a stable reference voltage circuit which operates in a low voltage without being affected substantially by process deviation and with no additional process.

FIG. 5 illustrates a reference circuit 200 according to a second exemplary embodiment of the present disclosure. In the second exemplary embodiment, a depression type MOS transistor is employed as the second MOS transistor M2. The reference circuit 200 includes a first MOS transistor M1 and the second MOS transistor M2. The first MOS transistor M1 has a lightly-doped gate and the second MOS transistor M2 has a heavily-doped gate which is dosed with impurity by a larger amount than doping in the lightly doped gate.

The first MOS transistor M1 is formed of an enhancement type MOS transistor and the second MOS transistor M2 is formed of a depression type MOS transistor by doping impurity in a channel region. The first and second MOS transistors M1 and M2 are connected between the power supply Vcc and ground. A gate of the first MOS transistor M1 is wired to the second MOS transistor M2. A substrate gate of the first MOS transistor M1 is wired to ground and a substrate gate of the second MOS transistor M2 is wired to the source of the second MOS transistor M2. The reference voltage Vref is drawn out from the connection node of the first and second MOS transistors M1 and M2.

Since the second MOS transistor M2 works as a constant current source and the source voltage of the first MOS transistor M1 is the ground voltage GND in this reference voltage circuit, the source voltage of the second MOS transistor M2 is equal to the potential difference of the source voltages of the first and second MOS transistors M1 and M2. Therefore, the reference voltage Vref is drawn out from the source of the second MOS transistor M2.

If the reference voltage Vref is approximately 0.5 v, it is easy to obtain the minimum operation voltage of the power supply Vcc which is lower than or equal to 1 v because a necessary drain-source voltage for the saturation operation of the depression MOS transistor M2 can be easily supplied. As a result, it is possible to obtain a similar effect as that of the first exemplary embodiment of the present disclosure.

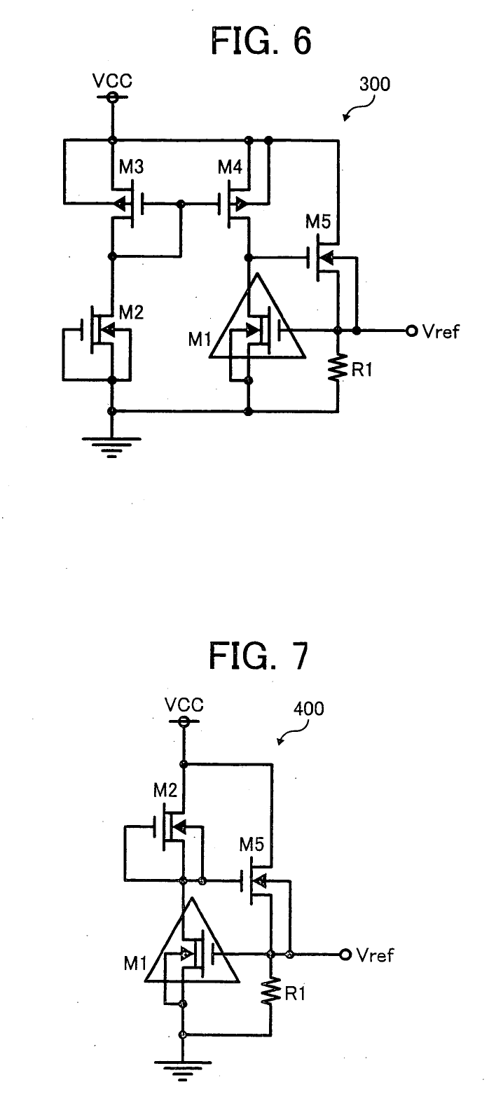

FIG. 6 illustrates a reference circuit 300 according to a third exemplary embodiment of the present disclosure. In the third exemplary embodiment, sources of the pair of MOS transistors, respectively, which are the first and second MOS transistors M1 and M2, are wired and a reference voltage Vref is drawn out as a potential difference between the gate voltages.

The reference circuit 300 includes first, second, third, fourth and fifth MOS transistors M1, M2, M3, M4 and M5 and a resistor R1. The first MOS transistor M1 is a N-channel enhancement type MOS transistor and has a lightly-doped gate. The second MOS transistor M2 is a N-channel depression type MOS transistor and has a heavily-doped gate which is dosed with impurity by a larger amount than doping in the lightly doped gate. The third and fourth MOS transistors M3 and M4 are P-channel enhancement type MOS transistors (PMOS transistor) and the fifth MOS transistor M5 is a N-channel enhancement type MOS transistor (NMOS transistor).

The fifth MOS transistor M5 and the resistor R1 form a bias circuit. Each source of the PMOS transistors M3 and M4 is wired to the power supply Vcc, and the gates are wired to each other. The connecting node of the gates is wired to the drain of the third MOS transistor M3 so that the third and fourth MOS transistors M3 and M4 form a current mirror circuit. Substrates of the PMOS transistors M3 and M4 are wired to the power supply Vcc.

The second MOS transistor M2 is connected between the PMOS transistor M3 and ground. The gate and substrate gate of the second MOS transistor M2 are wired to ground so as to form a constant current source. The first MOS transistor M1 is connected between the fourth MOS transistor M4 and ground. The substrate gate of the first MOS transistor M1 is wired to ground. Further, the fifth MOS transistor M5 and the resistor R1 are connected between the power supply Vcc and ground.

The gate of the fifth MOS transistor M5 is wired to the connecting node of the first MOS transistor M1 and the fourth MOS transistor M4. The substrate gate of the fifth MOS transistor M5 is wired to the source of the fifth MOS transistor M5. The gate of the first MOS transistor M1 is wired to the connecting node of the fifth MOS transistor M5 and the resistor R1. The reference voltage Vref is drawn out from the connecting node of the fifth MOS transistor M5 and the resistor R1. An amount of the current which flows in the first MOS transistor M1 is equal to an amount of the current of the second MOS transistor M2 because of the mirror circuit configuration by the PMOS transistors M3 and M4.

The fifth MOS transistor M5 forms a source follower circuit and creates a bias voltage for the gate of the first MOS transistor M1 so that idM1=idM2, where idM1 is a drain current of the first MOS transistor M1 and idM2 is a drain current of the second MOS transistor M2. The source voltage of the fifth MOS transistor M5, which is the gate voltage of the first MOS transistor M1, is a reference voltage Vref in this reference circuit 300.

The minimum operation voltage of the power supply Vcc becomes a summation of the reference voltage Vref, the source-gate voltage of the fifth MOS transistor M5 and the drain-source voltage of the fourth MOS transistor M4. The power supply voltage can be set to be lower than or equal to 1 v by controlling the threshold voltage of the fifth MOS transistor M5 so as to obtain a similar effect to the first exemplary embodiment.

FIG. 7 illustrates a reference circuit 400 according to a fourth exemplary embodiment of the present disclosure. In the fourth exemplary embodiment, the second MOS transistor M2 is formed of a depression type MOS transistor and is configured to be a constant current source. A current of the second MOS transistor M2 is directly fed to the first MOS transistor M1 in the reference circuit 400.

The reference circuit 400 includes first, second and fifth MOS transistors M1, M2, and M5 and the resistor R1. The first MOS transistor M1 is a N-channel enhancement type MOS transistor and has a lightly-doped gate. The second MOS transistor M2 is a N-channel depression type MOS transistor and has a heavily-doped gate which is doped with impurity in a larger amount than doping in the lightly doped gate. The fifth MOS transistor M5 is a N-channel enhancement type MOS transistor.

The first and second MOS transistors M1 and M2 are connected in series between the power supply Vcc and ground. The substrate gate of the first MOS transistor M1 is wired to ground. The gate and substrate gate of the second MOS transistor M2 are wired to the source of the second MOS transistor M2 so as to form a constant current source. The gate of the fifth MOS transistor M5 is wired to the connecting node of the gate, the substrate gate and the source of the second MOS transistor M2. Further, the fifth MOS transistor M5 and the resistor R1 are connected between the power supply Vcc and ground.

The substrate gate of the fifth MOS transistor M5 is wired to the source of the fifth MOS transistor M5. The connecting node of the substrate gate and the source of the fifth MOS transistor M5 is wired to the gate of the first MOS transistor M1. The reference voltage Vref is drawn out from the connecting node of the fifth MOS transistor M5 and the resistor R1. Namely, the reference voltage Vref is the gate-source voltage Vgs of the first MOS transistor M1.

In this circuit configuration, an amount of current which flows in the first MOS transistor M1 is equal to an amount of the current of the second MOS transistor M2 which forms a constant current source. The fifth MOS transistor MS forms a source follower circuit and creates a bias voltage for the gate of the first MOS transistor M1 so that idM1=idM2, where idM1 is a drain current of the first MOS transistor M1 and idM2 is a drain current of the second MOS transistor M2. The source voltage of the fifth MOS transistor MS, which is the gate voltage of the first MOS transistor M1, is a reference voltage Vref in this reference circuit 400.

The minimum operation voltage of the power supply Vcc becomes a summation of the reference voltage Vref, the source-gate voltage of the fifth MOS transistor MS and the drain-source voltage of the second MOS transistor M2. The power supply voltage can be set to be lower than or equal to 1 v by controlling the threshold voltages of the second and fifth MOS transistors M2 and MS so as to obtain a similar effect as that of the first exemplary embodiment.

The N-channel MOS transistors are employed for the first and second MOS transistors M1 and M2 in the first to fourth exemplary embodiments. However, it is possible to employ P-channel MOS transistors for the first and second MOS transistors M1 and M2. When the P-channel MOS transistors are employed, each channel type (N-channel/P-channel) of MOS transistors may be switched to reverse types as compared to those of the above exemplary embodiments, a positive power supply voltage may be set to be the ground voltage GND and the negative power supply voltage may be set to be a voltage lower than the ground voltage GND. Further, a depression MOS transistor may be employed as the first MOS transistor M1.

Numerous additional modifications and variations are possible in light of the above teachings. For example, elements and/or features of different examples and illustrative embodiments may be combined with each other and/or substituted for each other within the scope of this disclosure and appended claims. It is therefore to be understood that within the scope of the appended claims, the disclosure of this patent specification may be practiced otherwise than as specifically described herein.

This patent specification is based on Japanese patent application, No. 2005-321937 filed on Nov. 7, 2005 in the Japan Patent Office, the entire contents of which are incorporated by reference herein.

What is claimed is:

1. A reference voltage circuit comprising:
a first MOS transistor including a first gate, the first gate including a first conductive type impurity with a concentration less than or equal to 1×10¹² cm⁻³, or no impurity; and
a second MOS transistor including a second gate, the second gate including the first conductive type impurity or a second conductive type impurity with a concentration greater than or equal to 1×10¹⁹ cm⁻³,
wherein the reference voltage circuit generates a predetermined reference voltage by utilizing a difference of work functions between the first and second transistors so as to have no temperature dependence.

2. The reference voltage circuit of claim 1,
wherein each gate of the first and second MOS transistors is formed of poly-silicon or poly-silicon covered with silicide film.

3. The reference circuit of claim 1,
wherein the first and second MOS transistors have equal dimensional sizes with respect to an area at the substrate side from the gate oxide, including gate oxide, and equal distribution of the impurity concentration.

4. The reference voltage circuit of claim 1,
wherein the first and second MOS transistors have equal dimensional sizes to each other, except channel length.

5. The reference voltage circuit of claim 1,
wherein the first and second MOS transistors are connected in series and said first and second gates of the first and second MOS transistors are wired to each other,
and wherein a potential difference of the source voltages of the first and second MOS transistors is drawn out as the reference voltage.

6. The reference voltage circuit of claim 5,
wherein one of the first and second MOS transistors is formed of a depression MOS transistor and a gate of the depression MOS transistor is wired to a source of the depression MOS transistor so as to function as a constant current source,
and wherein the reference voltage is drawn out as a voltage between the gate and the source of another MOS transistor from a node at which a current is supplied from the constant current source.

7. The reference voltage circuit of claim 1,
wherein sources of the first and second MOS transistors are wired to each other,
and wherein the reference voltage is drawn out as a gate potential difference.

8. The reference voltage circuit of claim 7, further comprising:
a current mirror circuit configured to output an equal current of the second MOS transistor to the first MOS transistor;
a bias circuit configured to bias the first MOS transistor so as to make a first current of the first MOS transistor equal to a second current of the second MOS transistor,
wherein one of the first and second MOS transistors is formed of a depression MOS transistor and a gate of the depression MOS transistor is wired to a source of the depression MOS transistor so as to feed a constant current,
and wherein a voltage between the gate and the source of the first MOS transistor is output as the reference voltage.

9. The reference voltage circuit of claim 8,
wherein the bias circuit includes a source follower circuit which includes a third MOS transistor and a resistor connected in series between a positive power supply and a negative power supply.

10. The reference voltage circuit of claim 9,
wherein a gate of the third MOS transistor is wired to a connecting node of an output terminal of the current mirror circuit and the first MOS transistor,
and wherein a connecting node between the third MOS transistor and the resistor is wired to a gate of the first MOS transistor to feed a voltage to the gate of the first MOS transistor.

11. The reference voltage circuit of claim 1, further comprising:
a bias circuit configured to bias the first MOS transistor so as to make a current of the first MOS transistor equal to a current of the second MOS transistor,
wherein the second MOS transistor is formed of a depression MOS transistor and a gate of the second MOS transistor is wired to a source of the second MOS transistor to feed a predetermined constant current source to the first MOS transistor
and wherein a voltage between the gate and the source of the first MOS transistor is output as the reference voltage.

12. The reference voltage circuit of claim 11,
wherein the bias circuit includes a source follower circuit which includes a fourth MOS transistor and a resistor connected in series between a positive power supply and a negative power supply.

13. The reference voltage circuit of claim 12,
wherein a gate of the third MOS transistor is wired to a connecting node of the first and second MOS transistors,
and wherein a connecting node between the third MOS transistor and the resistor is wired to a gate of the first MOS transistor to feed a voltage back to the gate of the first MOS transistor.
